(19) United States
(12) Patent Application Publication
(10) Pub. No.: US 2018/0053379 A1
(43) Pub. Date: Feb. 22, 2018

(54) GAMING PRESENTATION SYSTEMS AND METHODS WITH IMPROVED MUSIC SYNCHRONIZATION

(71) Applicant: Everi Games, Inc., Austin, TX (US)

(72) Inventor: Steven Meyer, Austin, TX (US)

(73) Assignee: Everi Games, Inc., Austin, TX (US)

(21) Appl. No.: 15/240,857

(22) Filed: Aug. 18, 2016

(51) Int. Cl. G07F 17/32; G07F 17/34

(52) U.S. Cl. CPC G07F 17/3269; G07F 17/3244; G07F 17/3213; G07F 17/34

(57) ABSTRACT

A slot machine, gaming method, and program product are provided to dynamically display visual and audio content to be played in synchronization with a music track of any tempo. A software process is provided to time the beats of a song, and a high resolution timer sends beat events to gaming presentation processes to achieve a dynamic end-result that can be applied to a song of a desired tempo. The beat event is used to trigger additional presentation elements such as visual effects, sounds, and lighting on the beat of the background music. This approach allows any multimedia application to synchronize its presentation elements with the beat of a song, resulting in a dynamically orchestrated produce that feels cohesive and well composed.

### TECHNICAL FIELD OF THE INVENTION

The invention relates to multimedia displays for wagering games and synchronizing the same to music soundtracks.

### BACKGROUND OF THE INVENTION

Various slot machine games are known that provide wagering games in a variety of ways. These games often have background music or a musical soundtrack, which may be consistent with a theme of the game or may include popular music or other suitable soundtrack music.

U.S. Pat. No. 8,435,118B2 describes an audio system operable to play a bonus sound and a bang-up sound at the same time, such that the bonus and bang-up sounds are synchronized rhythmically.

Historically, the synchronization of multimedia elements with a background music track was accomplished by authoring all content to align with a specific beat. The content and background music would need to be started at the same time, and volume or display settings were used to mimic turning ‘on’ and ‘off’ various aspects of the presentation. This approach required all content to be re-authored for each background song and limited the synchronization to music tracks of a pre-decided temp.

What is needed are better ways to synchronize designated musical tracks with the presentation of a slot machine game, in order to increase player excitement and enjoyment of slot machine games.

### SUMMARY OF THE INVENTION

The invention solves the problem of being able to dynamically display visual and audio content to be played in synchronization with a music track of any tempo. The approach described in this invention allows the flexibility of creating a dynamic arrangement which allows any display elements and sound samples to be played in synchronization with any music track. Songs may be pre-processed with tempo and timing information, or an on demand audio processing system may be provided to synchronize a new music file or streamed audio to a gaming presentation. A software process is provided to time the beats of a song, and a high resolution timer sends beat events to gaming presentation processes to achieve a dynamic end-result that can be applied to a song of a desired tempo. The use of a high resolution timer to track the BPM (beats per minute) of a music soundtrack and produce a software notification (callback, event, signal, or other suitable software message) of each beat as the music track is playing provides ability for gaming modules to each be programmed to respond to beats in their own desired manner. The beat event or beat message is used to trigger additional presentation elements such as visual effects, sounds, and lighting on the beat of the background music. This approach allows any multimedia application to synchronize its presentation elements with the beat of a song, resulting in a dynamically orchestrated produce that feels cohesive and well composed.

According to a first embodiment, a gaming machine is provided for conducting a wagering game. The machine includes a display, an audio device, a wager input device, and at least one electronic controller operatively coupled to the wager input device, the audio device, and the display and configured to execute instructions related to the wagering game and to cause cash value credits to be awarded to a player in response to wagering wins. The machine is run by software programming stored in a tangible, non-transitory electronically accessible memory coupled to the at least one electronic controller. The software includes program code executable by the at least one electronic controller to:
(a) receive an instruction that a first audio file is to be played as a music accompaniment during a game play session;
(b) in response, determining one or more musical beat rates and associated start times describing music recorded in the audio file;
(c) provide the one or more musical beat rates and associated start times to a timer;
(d) cause the first audio file to be played through the audio device while the game play session is in progress;
(e) while the file is played, cause the timer to measure time intervals between beats in the played audio, and send beat events to multimedia display program code synchronized with the beats in the played audio; and
(f) in response to the beat events and synchronized with the beats in the played audio, animating graphical display elements on the display during the game play session.

Another version of the invention is a software or software/firmware program stored on a non-transitory readable medium. The software version is, of course, typically designed to be executed by a gaming machine or networked gaming system. The software includes multiple portions of computer executable code referred to as program code. Gaming results are provided in response to a wager and displayed by display program code that generates simulated slot reels each including one or more symbol locations. The software includes the program code for controlling a high resolution timer to time musical beats and send beat messages to gamin process for synchronizing the gaming multimedia presentation. The software also includes the various gaming processes that receive beat messages and respond with various programmed activity to synchronize the presentation.

Another version of the invention is a gaming system that includes one or more gaming servers, and a group of electronic gaming machines connected to the servers by a network, programmed as set forth above. The various functionality described herein may be distributed between the electronic gaming machines and the gaming servers in any practically functional way. For example, the current preferred architecture is for the servers to determine all aspects of game logic, random number generation, and prize awards. The gaming machines provide functionality of interfacing with the player and animating the game results received from the server in an entertaining manner. However, other embodiments might use a thin client architecture in which the animation is also conducted by the server, and electronic gaming machines serve merely as a terminal to receive button or touch screen input from the player and to display graphics received from the server.

Different features may be included in different versions of the invention. For example, some versions may not include the actual processing of the musical track, which may be done in advance or on demand with new musical tracks or streams. In some versions, beat events are sent as an inter-process message on a virtual unified message bus. Such messages may be sent between networked devices, over a local bus, or to different processes in the same processor, which may be running on different processor cores or the same processor core. Consistent with the structure of music in measures having down beats and off beats, the beat messages may have DOWN BEAT type and OFF BEAT type, or the timer or processes may count beats the beats to identify a beat message as such, and processes may respond differently to different beat types.

In some versions, new songs may be provided from various sources, or an audio track or stream may be provided including several songs, such as a live concert stream, which could be at a casino or a concert recording.

These and other advantages and features of the invention will be apparent from the following description of the preferred embodiments, considered along with the accompanying drawings.

### BRIEF DESCRIPTION OF THE DRAWINGS

FIG. 1 is a screen display diagram showing the primary display and secondary (top) display to illustrate an example slot machine display arrangement.

FIG. 2A is a messaging diagram showing functions and messages between various system modules according to this example embodiment.

FIG. 2B is a flowchart of a process conducted with the gaming machine according an example embodiment.

FIG. 3A is a front perspective view of a gaming machine which may be used in a gaming system embodying the principles of the present invention.

FIG. 3B is a block diagram showing various electronic components of the gaming machine shown in FIG. 3A together with additional gaming system components.

FIG. 3C is a software block diagram showing various program code modules and libraries according to an example embodiment.

FIG. 4A is a system block diagram of a gaming system according to one embodiment of the present invention.

FIG. 4B is a system block diagram of a gaming system according to another embodiment.

### DETAILED DESCRIPTION OF PREFERRED EMBODIMENTS

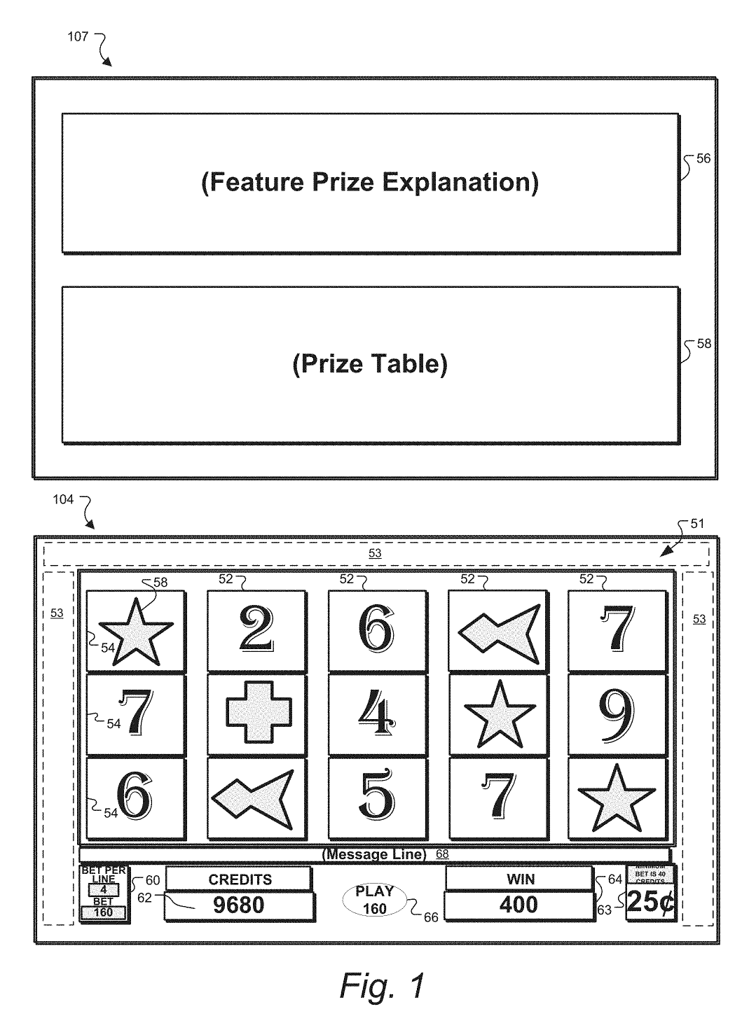

FIG. 1 is a screen display diagram showing the primary display 104 and secondary (top) display 107 to illustrate an example slot machine display arrangement on which wagering game results are presented in a gaming area, typically found on the primary display. On the secondary display 107 in box 56 are the instructions for playing the game. Underneath the instructions, a prize table is shown in box 58, are the prizes that can be won as well as the requirements for winning. Background, side, and top graphics 53 may be animated during or between games as part of the multimedia theme of the game as further discussed below.

The gaming area of a reel-type primary game (as opposed to bonus games or other special games) in this version is a matrix 51 of symbol locations arranged in rows and columns to represent simulated slot machine reels that are spun to conduct a game round. Other embodiments may, of course, use other types of game displays to display randomizing of symbols according to the methods herein. The depicted columns of symbols labeled 52 represent the simulated reels, while symbols are designated 54. In this instance there are five reels with three symbol locations 54 displayed at a time on each reel, but the game can be played with more and less reels. The simulated reel typically has far more symbols than those displayed, and as many unique stop positions as there are symbols on the simulated reel. The stop position may be counted, for example, by numbering the symbols on the simulated reel and using the number of the symbol at the bottom of the display window (the three symbols displayed in this example), or at the top or middle. Further, while multi-symbol reels are shown, other versions may use simulated uni-symbol reels, or a reel that has many symbols thereon but only a single window to the reel simulated, displaying a single symbol from the reel. Some variations of the present invention may use a simulated uni-symbol reel in each depicted symbol location 54. Surrounding the matrix 51 is background graphics 53, which may be above, beside, below, between or behind the symbol locations 54 of matrix 51.

Winning patterns are typically formed by matching symbols along defined paylines that pass through the matrix 51. Box 60, which displays the current wager and amount bet per payline. To the right of box 60 is box 62, which displays the current credits in the player's account. In the bottom center a touchscreen play button 66 is presented in the lower central area of the display, which may show other game state related graphics. Right of this is win box 64, which displays the player's last awarded winnings. The wager credit denomination is shown in box 63. Along the bottom edge of the matrix 51 there is a message line, where the game station can display further instructions to the player.

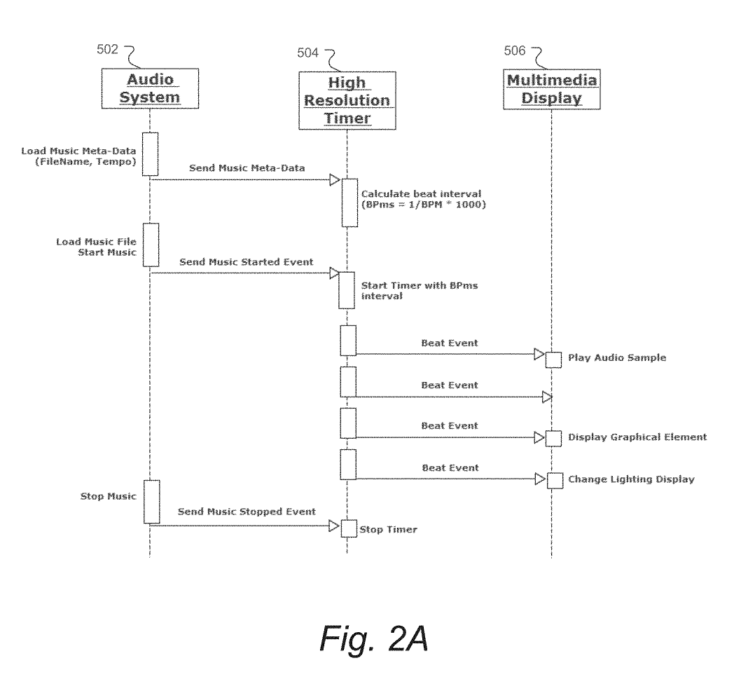

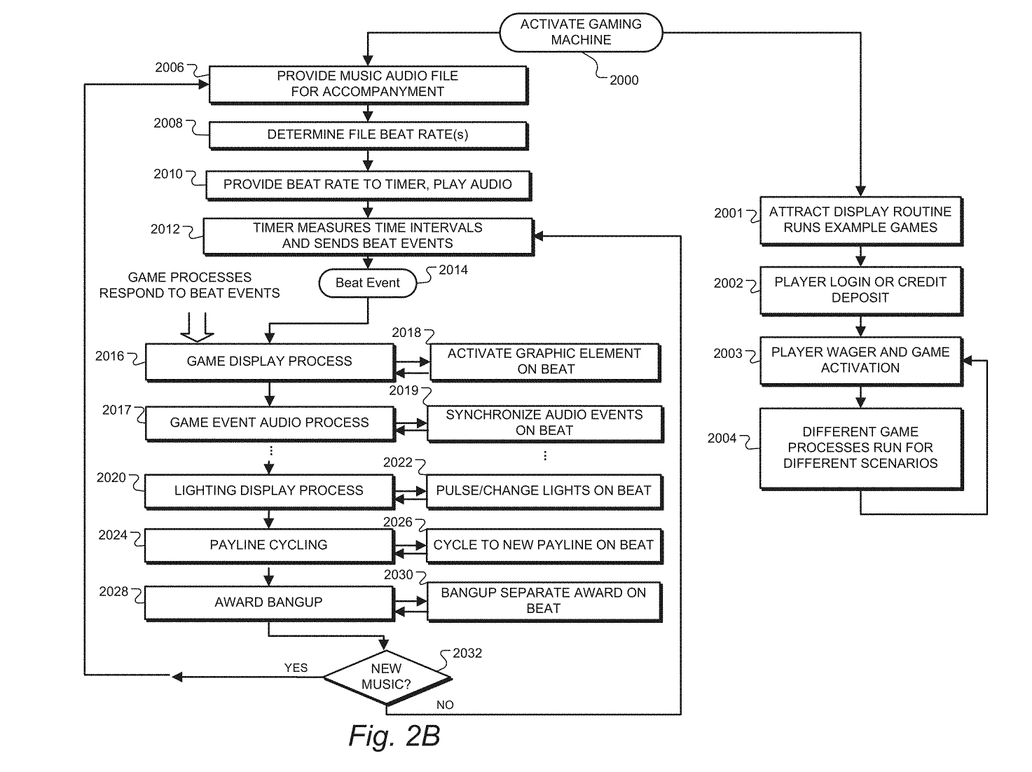

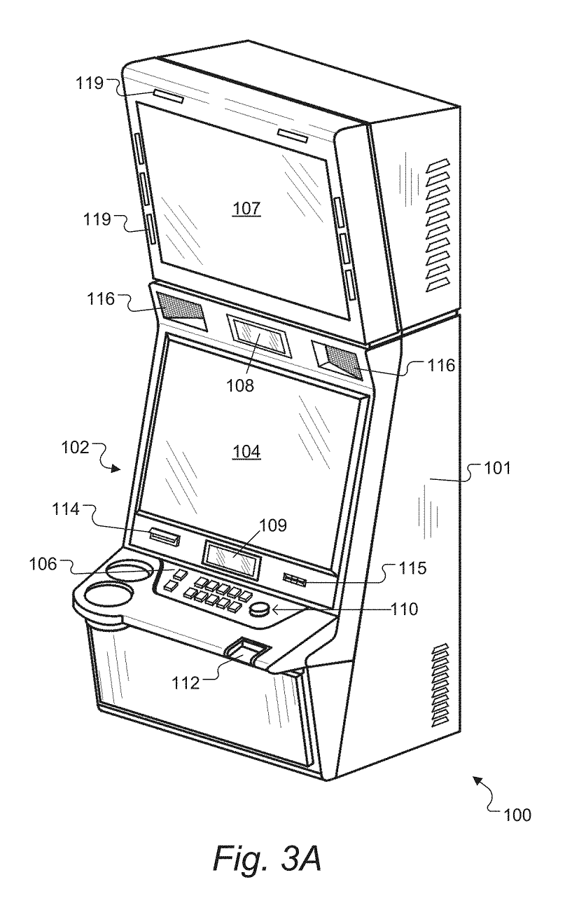

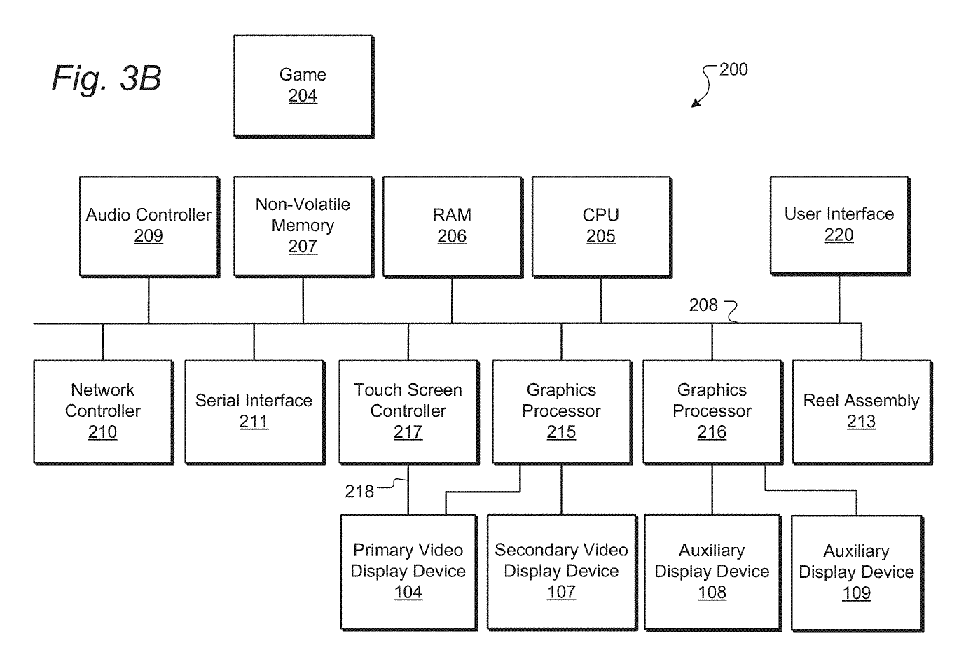

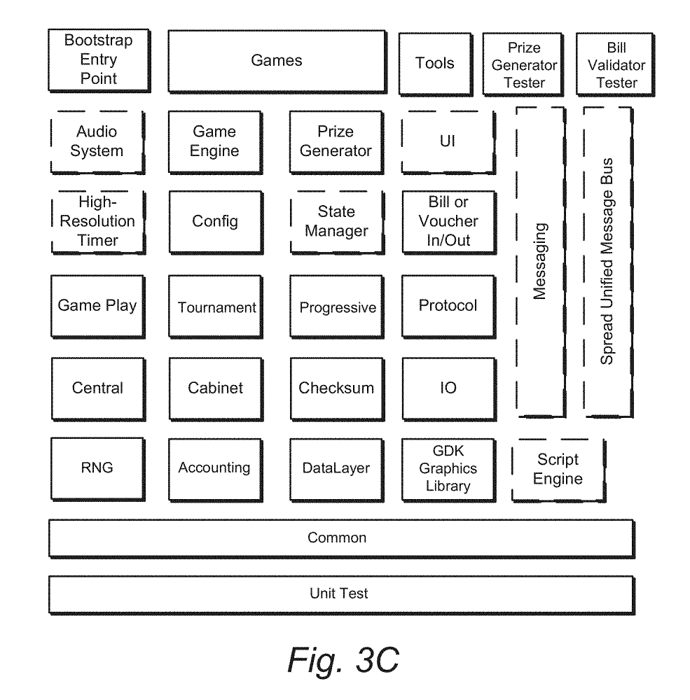

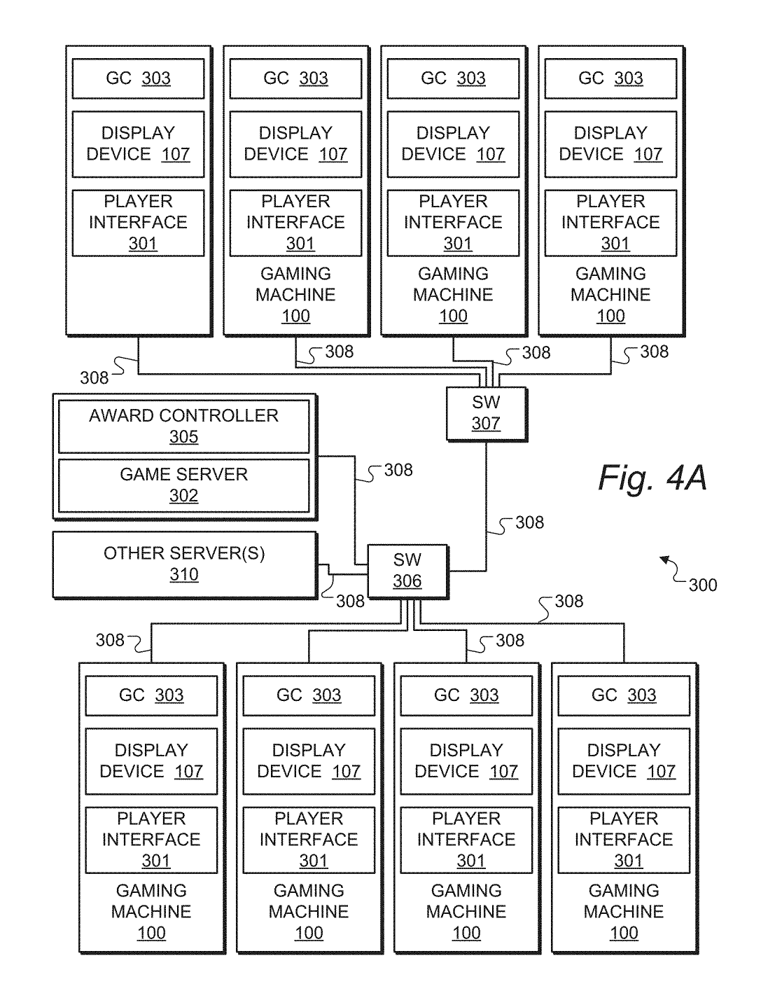

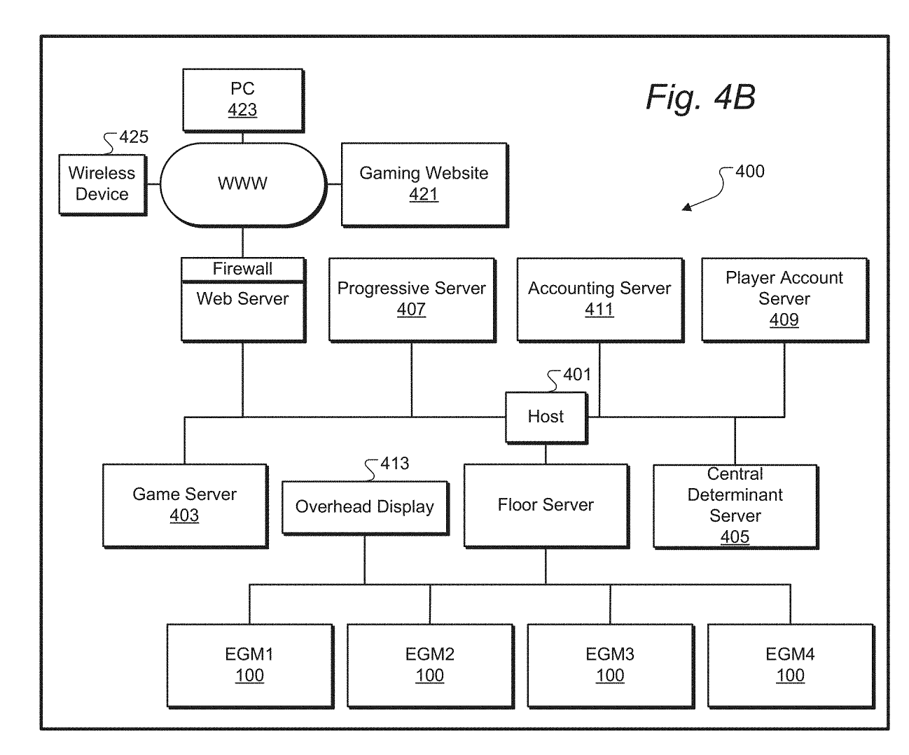

FIGS. 2A and 2B generally illustrate techniques for synchronizing the multimedia presentation of the game as presented on the various displays and lights of a gaming cabinet such as that in FIG. 3A. FIG. 2A is a messaging diagram showing functions and messages between various system modules according to this example embodiment. FIG. 2B is a flowchart of a process conducted with the gaming machine according an example embodiment. Referring to both Figures, an example embodiment of the invention provides synchronization of music or other accompanying audio to the multimedia presentation of the wagering game for gaming machines such as machines 100 on a gaming network 308 as shown, for example, in FIG. 4A. The multimedia synchronization process typically begins with the machine startup up or activation at block 2000. The machine then runs an attract routine showing example games being conducted at block 2001. This block will employ various processes or software submodules, as shown, for example, in FIG. 3C. On the left of FIG. 2B is shown several process blocks that provide synchronization of the background music to the gaming events, and may run simultaneously to the gaming routines in the various states in which the gaming machine operates with background music.

The depicted process allows any desired background music, assuming it a periodic beat or drum track to which the multimedia presentation is to be synchronized, to be provided for use at block 2006. In some versions, new songs may be provided from various sources, or an audio track or stream may be provided including several songs, such as a live concert stream, which could be at a casino or a concert recording. As such, an audio file or audio stream may be provided at block 2006. The process at block 2006 receives an instruction that a first audio file or stream is to be played as a music accompaniment during a game play session, which instruction may come from state management software code running on the gaming machine, or from a central multimedia server or other suitable casino floor coordination system. Next at block 2008, the method continues by examining the file or stream to determine one or more musical beat rates and associated start times describing music recorded or streamed in the audio. In the simplest form, this step simply reads a pre-existing piece of data such as metadata containing the beat rate of the music in the file, and if the beat is not started at the zero time in the file, the time offset for the start of the beat rate. If more than one beat rate exists in the music file, each beat rate may be stored with its start time. A start time is provided for the first beat of a new tempo whenever the beat rate changes within an audio file or stream. In versions where beat rates are not stored with each file, block 2008 may process the music file by performing frequency analysis or other beat counting analysis known in the music industry to determine the beat rates and start times. In another variation, where the music is not provided as a file but instead as a live stream from a concert or an audio stream from a central media server, process may track the beat rate on an ongoing basis. This process may be done by an audio system 502 running on the gaming machine 100, in some cases with a new music file or stream provided from a source connected to the network with the gaming machine. In other versions, the audio system 502 may run on a central multimedia server (one of other servers 310 in FIG. 4A), which may process music files or streams in advance and provide instructions to the individual gaming machines on the network such as network 308 (FIG. 4A). Next at block 2010, the process provides the one or more musical beat rates and associated start times to a timer. The timer preferably runs as a local process on the gaming machine 100. The timer process is preferably a high resolution timer able to time the progress of the audio file or stream playback with microsecond precision, so as to coordinate the multimedia display of each graphical, lighting, sound, or animation element with the desired timing relative to the musical beats, whether some actions begin before the beginning of the musical beat or conclude after it, allowing any desired synchronization of the multimedia gaming elements with the background music.

Still referring to block 2010, the audio system 502 causes the audio file to be played through the audio device while the game play session at blocks 2002-2004 is in progress. While the file is played, the method causes the timer process 504 to measure time intervals between beats in the played audio, and send beat events (block 2014) to multimedia display program code 506 synchronized with the beats in the played audio.

In response to the beat events and synchronized with the beats in the played audio, the multimedia display program code 506 causes animating graphical display elements on the display during the game play session. The beat event may be sent as an inter-process message through a virtual message bus such as the Spread Unified Messaging Bus (FIG. 3C), or may be another suitable type of software message or interrupt event. As depicted in FIG. 2B, different processes or code modules may be running that respond differently to a beat event. Generally, the different processes at blocks 2016, 2017, 2020, 2024, and 2028 may not always be running as process threads or related groups of process threads, or may be placed in a state in which they do not respond to beat events. The block diagrams herein show behavior in which such processes are, according to their programming, in a state to respond to the beat events as depicted. The game display process, as shown at block 2016, may activate any number of graphic elements on a beat, such as animating a flash or pulse of light for a reel symbol 58, or animating a change in reel symbols with the beat. The game display process may also animate the background graphics 53 in time with the music beat. While the term “process” is used here, one or more than one actual microprocessor process, or thread, of related software instructions may run to control the steps described in response to the beat event. A single process may also control the response for more than one of the depicted events 2018, 2019, 2022, 2026, and 2030 and other similar events. In some versions, beat events are sent as an inter-process message on a virtual unified message bus. Such messages may be sent between networked devices, over a local bus, or to different processes in the same processor, which may be running on different processor cores or the same processor core.

The game event audio process at block 2017 is another process that may respond to beat events. The software further comprises instructions for providing game event audio accompanying selected events in the game play session at block 2019, and further operable to mix the game event audio with the played audio such that designated sounds (typically beats or emphatic sounds) in the game event audio are synchronized with the beats in the played audio.

It is noted the ellipsis between blocks 2017 and 2020 shows more gaming processes may be present which respond in different ways to beat events in the game soundtrack or background music. The depicted order of events is not limiting as the processes are typically event driven and run in parallel.

Next at block 2020 the gaming machine lighting display process software code (which generally part of the multimedia display software modules in the gaming software, but may include drivers and other related code), receives the beat event and goes on to respond in some cases, as programmed, to pulse, flash, change color, or otherwise adjust the lighting condition or state synchronized in time to the soundtrack beat. As shown in the next several blocks, designated ones of the beat events may trigger responses from various game play processes executing in the game. The lights employed on the gaming cabinet may be one or more lights such as lights 119 (FIG. 3A) having control electronics operatively coupled to at least one electronic controller in the gaming cabinet.

Next at block 2024, a payline cycling process is shown to receive the beat event. This process runs during the award phase of a winning game in which the wagering game includes multiple paylines which are evaluated for game results in a payline evaluation phase of the game play session. The response software code typically includes instructions for providing a graphical display of cycling through the payline evaluation synchronized with the beats in the played audio, as seen at block 2026. The beats can be main beats of a measure, with no response on off beats, mimicking an arrangement in which the display has a custom animation sequence for each song.

Next at block 2028 the process has another gaming presentation process that receives and responds to beat events, the award bang-up process, which shows awards from base or bonus games being added to the players credit total. The award bang-up process at block 2028 will be activated after designated winning outcomes, and may wait for the first beat event before making any multimedia presentation of the award bang-up. This process typically controls both audio and display animation to show the credit meter ‘bang-up’ at block 2030. The audio includes a bang-up soundtrack synchronized with the beats in the played audio, and a bang-up graphic sequence is displayed with the bang-up soundtrack showing credits incrementally awarded to a player also synchronized with the beats in the played audio.

Next at block 2032, the process may be provided a new piece of music to use as the game soundtrack, in which case it returns to block 2006 to obtain the new music and determine or obtain the beat rates and start times for the timer process to use. A new music file or stream may be provided in a number of different ways, such as from a game play process which may cycle through a number of songs consistent with a theme, or a multimedia server controlling multiple gaming machines on a casino floor. Similarly to the first music described above, the new music may be a song, a background music track, or other game soundtrack. A new song may be started, for example, in response to a bonus portion of the game play session being entered. If no new music is provided after the beat event at block 2032, the method returns to the timer process at block 2012 where the next beat is awaited. Consistent with the structure of music in measures having down beats and off beats, the beat messages may have DOWN BEAT type and OFF BEAT type, or the timer or processes may count beats the beats to identify a beat message as such, and processes may respond differently to different beat types.

Referring again to the right-hand depicted blocks, a game play session is begun when a player logs in to a credit account on the gaming machine, or deposits credits in the form of cash or a voucher or token of some kind at block 2002. To begin a game play, the method receives a wager from the game player at block 2003, which typically consists of some input from the player to set the amount to be wagered from their credit amount on the machine. This step may also be carried over from previous game rounds by simply starting the game with the previous wager amount set. Then, the method receives a play input from the player. This typically happens through a ‘Play’ button on the game cabinet or touchscreen display, and serves to place the wager and start a single round of game play in the base game. In embodiments having reels, reel displays, or simulated reels, this is conducted by spinning the reels. Other embodiments may otherwise rearrange or randomize the symbols on the matrix in any suitable manner. After the game activation in step 2003, the method randomly determines the game outcome, preferably by randomly determining a set of reel stops that determine which symbols fill the matrix for the current game outcome at step 2004. For games that use other scrambling besides simulated reels, the random outcome is determined at this step as appropriate for the game. The preferred version generates at least one random number and uses the at least one random number to determine a set of game reel stops specifying a position in which multiple simulated or mechanical reels will stop to display symbols in a symbol array in a spin outcome for the wager.

Further, while the system computer executable instructions described above are preferably executed by a Class III gaming machine as further discussed below, it should be understood that this is only one example embodiment, and other versions may divide the processing tasks of the game method in a different manner. For example, some systems may employ a thin client architecture in which practically all of the processing tasks are performed at the game server, and only display information for the player interface transmitted to the electronic gaming machine. In such an embodiment, only the steps involving player input or display are performed by the electronic gaming machine, with the remaining steps performed by one of the game servers in the system. In such a case, though, the software architecture is preferably designed as a thin client in which a dedicated virtual machine running on the game server (or a virtual machine server connected in the gaming network) performs the tasks designated in the present drawing as occurring “at the gaming machine.” In the depicted method, the method is performed by the respective computer hardware operating under control of computer program code. While central processor arrangements may vary (for example award controllers may be integrated on the same machine with a gaming server, or may be a separate server connected on a secure network), the particular central determinant architecture is not limiting and will be referred to generally in this drawing as the game server (i.e. 302, 403). As shown at step 2003 in FIG. 2A, the method performed at the game server further includes receiving game play requests originating from electronic gaming machine 100, and sending commands to the gaming machine to show reels spinning, the player selection rounds with their persistent indicia, and results being displayed. The division of game logic steps between gaming machines and servers is known in the art and may be accomplished according to suitable methods allowed for the relevant gaming jurisdictions.

FIG. 3A shows a gaming machine 100 that may be used to implement an automated multimedia gaming presentation according to the present invention. The block diagram of FIG. 3B shows further details of gaming machine 100. Referring to FIG. 3A, gaming machine 100 includes a cabinet 101 having a front side generally shown at reference numeral 102. A primary video display device 104 is mounted in a central portion of the front surface 102, with a ledge 106 positioned below the primary video display device and projecting forwardly from the plane of the primary video display device. In addition to primary video display device 104, the illustrated gaming machine 100 includes a secondary video display device 107 positioned above the primary video display device. Gaming machine 100 also includes two additional smaller auxiliary display devices, an upper auxiliary display device 108 and a lower auxiliary display device 109. It should also be noted that each display device referenced herein may include any suitable display device including a cathode ray tube, liquid crystal display, plasma display, LED display, or any other type of display device currently known or that may be developed in the future.

In preferred versions, the gaming machine 100 illustrated in FIG. 3A also includes a number of mechanical control buttons 110 mounted on ledge 106. These control buttons 110 may allow a player to select a bet level, select pay lines, select a type of game or game feature, and actually start a play in a primary game. Other forms of gaming machines according to the invention may include switches, joysticks, or other mechanical input devices, and/or virtual buttons and other controls implemented on a suitable touch screen video display. For example, primary video display device 104 in gaming machine 100 provides a convenient display device for implementing touch screen controls.

It will be appreciated that gaming machines may also include a number of other player interface devices in addition to devices that are considered player controls for use in playing a particular game. Gaming machine 100 also includes a currency/voucher acceptor having an input ramp 112, a player card reader having a player card input 114, and a voucher/receipt printer having a voucher/receipt output 115. Audio speakers 116 generate an audio output to enhance the user's playing experience. Decorative lights 119 are placed, in this version, along the top of the machine and beside secondary display 107, but may also be in other suitable locations such a topper light on the top surface, along the machine's belly (the front panel under the ledge 106) or behind translucent portions of the machine belly glass, around primary display 104, or on the cabinet sides as well. These lights may be controlled to dim, flash, change colors, or otherwise alter along with the musical beats as described herein. Numerous other types of devices may be included in gaming machines that may be used according to the present invention.

FIG. 3B shows a logical and hardware block diagram 200 of gaming machine 100 which includes a central processing unit (CPU) 205 along with random access memory 206 and nonvolatile memory or storage device 207. All of these devices are connected on a system bus 208 with an audio controller 209, a network controller 210, and a serial interface 211. A graphics processor 215 is also connected on bus 208 and is connected to drive primary video display device 104 and secondary video display device 107 (both mounted on cabinet 101 as shown in FIG. 3A). A second graphics processor 216 is also connected on bus 208 in this example to drive the auxiliary display devices 108 and 109 also shown in FIG. 3A. As shown in FIG. 3B, gaming machine 100 also includes a touch screen controller 217 connected to system bus 208. Touch screen controller 217 is also connected via signal path 218 to receive signals from a touch screen element associated with primary video display device 104. It will be appreciated that the touch screen element itself typically comprises a thin film that is secured over the display surface of primary video display device 104. The touch screen element itself is not illustrated or referenced separately in the figures.

Those familiar with data processing devices and systems will appreciate that other basic electronic components will be included in gaming machine 100 such as a power supply, cooling systems for the various system components, audio amplifiers, and other devices that are common in gaming machines. These additional devices are omitted from the drawings so as not to obscure the present invention in unnecessary detail.

All of the elements 205, 206, 207, 208, 209, 210, and 211 shown in FIG. 3B are elements commonly associated with a personal computer. These elements are preferably mounted on a standard personal computer chassis and housed in a standard personal computer housing which is itself mounted in cabinet 101 shown in FIG. 3A. Alternatively, the various electronic components may be mounted on one or more circuit boards housed within cabinet 101 without a separate enclosure such as those found in personal computers. Those familiar with data processing systems and the various data processing elements shown in FIG. 3B will appreciate that many variations on this illustrated structure may be used within the scope of the present invention. For example, since serial communications are commonly employed to communicate with a touch screen controller such as touch screen controller 217, the touch screen controller may not be connected on system bus 208, but instead include a serial communications line to serial interface 211, which may be a USB controller or a IEEE 1394 controller for example. It will also be appreciated that some of the devices shown in FIG. 3B as being connected directly on system bus 208 may in fact communicate with the other system components through a suitable expansion bus. Audio controller 209, for example, may be connected to the system via a PCI bus. System bus 208 is shown in FIG. 3B merely to indicate that the various components are connected in some fashion for communication with CPU 205 and is not intended to limit the invention to any particular bus architecture. Numerous other variations in the gaming machine internal structure and system may be used without departing from the principles of the present invention.

It will also be appreciated that graphics processors are also commonly a part of modern computer systems. Although separate graphics processor 215 is shown for controlling primary video display device 104, secondary video display device 107, and graphics processor 216 is shown for controlling both auxiliary display devices 108 and 109, it will be appreciated that CPU 205 may control all of the display devices directly without any intermediate graphics processor. The invention is not limited to any particular arrangement of processing devices for controlling the video display devices included with gaming machine 100. Also, a gaming machine implementing the present invention is not limited to any particular number of video display device or other types of display devices.

In the illustrated gaming machine 100, CPU 205 executes software which ultimately controls the entire gaming machine including the receipt of player inputs and the presentation of the graphic symbols displayed according to the invention through the display devices 104, 107, 108, and 109 associated with the gaming machine. As will be discussed further below, CPU 205 either alone or in combination with graphics processor 215 may implement a presentation controller for performing functions associated with a primary game that may be available through the gaming machine and may also implement a game client for directing one or more display devices at the gaming machine to display and perform the multimedia presentation techniques of the present invention. CPU 205 also executes software related to communications handled through network controller 210, and software related to various peripheral devices such as those connected to the system through audio controller 209, serial interface 211, and touch screen controller 217. CPU 205 may also execute software to perform accounting functions associated with game play. Random access memory 206 provides memory for use by CPU 205 in executing its various software programs while the nonvolatile memory or storage device 207 may comprise a hard drive or other mass storage device providing storage for programs not in use or for other data generated or used in the course of gaming machine operation. Network controller 210 provides an interface to other components of a gaming system in which gaming machine 100 is included. In particular, network controller 210 provides an interface to a game controller which controls certain aspects of the player selection round as will be discussed below in connection with FIGS. 3A-B.

FIG. 3C shows a software module block diagram according to one example version of the invention. The software modules depicted may be instantiated as processes communicating with inter-thread messaging according to suitable techniques known in the art. Generally, the modules employed for synchronizing the multimedia presentation with the musical soundtrack are highlighted with dotted blocks. The Spread unified messaging bus, a virtual messaging bus, may be employed as shown to implement the beat messages passed to the UI and Script Engine modules, which generally contain the gaming presentation software program code. While this architecture is shown, many other software designs are possible within the scope of the invention to achieve the same result.

It should be noted that the invention is not limited to gaming machines employing the personal computer-type arrangement of processing devices and interfaces shown in example gaming machine 100. Other gaming machines through which the automated multimedia presentation techniques herein are implemented may include one or more special purpose processing devices to perform the various processing steps for implementing the present invention. Unlike general purpose processing devices such as CPU 205, these special purpose processing devices may not employ operational program code to direct the various processing steps.

It should also be noted that the invention is not limited to gaming machines including only video display devices for conveying results. It is possible to implement the base game within the scope of the present invention using an electro mechanical arrangement or even a purely mechanical arrangement for displaying the symbols needed to complete the game as described herein. However, the most preferred forms of the invention utilize one or more video display devices for displaying the spinning reels, the animated symbols, and the other synchronized multimedia animations.

Still referring to the hardware and logical block diagram 200 showing an example design for a gaming machine 100, the depicted machine in operation is controlled generally by CPU 205 which stores operating programs and data in memory 207 with wagering game 204, user interface 220, network controller 210, audio/visual controllers, and reel assembly 213 (if a mechanical reel configuration). CPU or game processor 205 may comprise a conventional microprocessor, such as an Intel® Pentium® microprocessor, mounted on a printed circuit board with supporting ports, drivers, memory, software, and firmware to communicate with and control gaming machine operations, such as through the execution of coding stored in memory 207 including one or more wagering games 204. Game processor 205 connects to user interface 220 such that a player may enter input information and game processor 205 may respond according to its programming, such as to apply a wager and initiate execution of a game.

Game processor 205 also may connect through network controller 210 to a gaming network, such as example casino server network system 400 shown in FIG. 4B. Referring now to FIG. 4B, the casino server system 400 may be implemented over one or more site locations and include host server 401, remote game play server 403 (which may be configured to provide game processor functionality including determining game outcomes and providing audio/visual instructions to a remote gaming device), central determinant server 405 (which may be configured to determine lottery, bingo, or other centrally determined game outcomes and provide the information to networked gaming machines 100 providing lottery and bingo-based wagering games to patrons), progressive server 407 (which may be configured to accumulate a progressive pool from a portion of wagering proceeds or operator marketing funds and to award progressive awards upon the occurrence of a progressive award winning event to one or more networked gaming machines 100), player account server 409 (which may be configured to collect and store player information and/or awards and to provide player information to gaming machines 100 after receiving player identification information such as from a player card), and accounting server 411 (which may be configured to receive and store data from networked gaming machines 100 and to use the data to provide reports and analyses to an operator). Through its network connection, gaming machine 100 may be monitored by an operator through one or more servers such as to assure proper operation, and, data and information may be shared between gaming machine 100 and respective of the servers in the network such as to accumulate or provide player promotional value, to provide server-based games, or to pay server-based awards.

Referring now to FIG. 4A, a gaming system 300 according to another embodiment of the present invention is shown again in a network and system diagram format. System 300 includes a number of gaming machines, each comprising a gaming machine 100 in this example implementation. For purposes of describing system 300, each gaming machine 100 in FIG. 4A is shown as including a video display device 107 and a player interface that may include buttons, switches, or other physical controls and/or touch screen controls as discussed above in connection with FIG. 4A. This player interface is labeled 301 in FIG. 4A. System 300 further includes a game server 302 and a respective game client 303 (abbreviated “GC” in FIG. 4A) included with each respective gaming machine 100. In the form of the invention shown in FIG. 4A these two components, game server 302 and the game client components 303 combine to implement a game control arrangement which will be described in detail below. System 300 also includes an award controller 305, which is shown in FIG. 4A as being associated with game server 302 to indicate that the two components may be implemented through a common data processing device/computer system. Gaming machines 100, game server 302, and award controller 305 are connected in a network communication arrangement including first and second network switches 306 and 307, connected together through various wired or wireless signal paths, all shown as communications links 308 in FIG. 4A.

Each gaming machine 100, and particularly player interface 301 associated with each gaming machine, allows a player to make any inputs that may be required to make the respective gaming machine eligible for the game, and make selections of selectable objects displayed at the respective gaming machine in the course of the player selection round. Player interface 301 also allows a player at the gaming machine to initiate plays in a primary game available through the gaming machine in some implementations. The respective video display device 107 associated with each respective gaming machine 100 is used according to the invention to generate the graphic displays to show the various elements of a player selection round at the respective gaming machine.

The game control arrangement made up of game server 302 and the respective game client 303 at a given gaming machine functions to control the respective video display device 107 for that gaming machine to display the selectable objects. Award controller 305 is responsible for awarding prizes for a player's participation, and maintaining progressive prize information where the game offers one or more progressive prizes. The network arrangement made up of network switches 306 and 307, and the various communication links 308 shown in FIG. 4A is illustrated merely as an example of a suitable communications arrangement. It should be noted that the game control arrangement, or as it is referred to generally the “game controller,” may be implemented in some embodiments entirely on the gaming machine. This is especially true in jurisdictions that allow Class III gaming conducted with random number generators at each gaming machine. The present invention is not limited to any particular communications arrangement for facilitating communications between game server 302 and various gaming machines 100. Any wired or wireless communication arrangement employing any suitable communications protocols (such as TCP/IP for example) may be used in an apparatus according to the invention.

FIG. 4A shows other server(s) 310 included in the network. This illustrated “other server(s)” element 310 may include one or more data processing devices for performing various functions related to games conducted through system 300 and any other games that may be available to players through gaming machines 100. For example, apparatus 300 may be accounting servers providing support for cashless gaming or various forms of mixed cash/cashless gaming through the various gaming machines 100. In this example, an additional one of the other servers 310 will be included in apparatus 300 for supporting these types of wagering and payout systems. As another example, the various gaming machines 100 included in system 300 may allow players to participate in a game (primary game) other than the game described herein, and this other game may rely on a result identified at or in cooperation with a device that is remote from the gaming machines. In this example, another server 310 may be included in the system for identifying results for the primary game and communicating those results to the various gaming machines 100 as necessary. Generally, the other server(s) 310 shown in FIG. 4A are shown only to indicate that numerous other components may be included along with the elements that participate in providing persistent indicia features according to the present invention. Other server(s) 310 may provide record keeping, player tracking, accounting, result identifying services, or any other services that may be useful or necessary in a gaming system.

Referring to FIG. 4B, a block diagram of another example networked gaming system 400 associated with one or more gaming facilities is shown, including one or more networked gaming machines 100 in accordance with one or more embodiments. With reference to FIG. 4B, while a few servers have been shown separately, they may be combined or split into additional servers having additional capabilities.

As shown, networked gaming machines 100 (EGM1-EGM4) and one or more overhead displays 413 may be network connected and enable the content of one or more displays of gaming machines 100 to be mirrored or replayed on an overhead display. For example, the primary display content may be stored by the display controller or game processor 205 and transmitted through network controller 210 to the overhead display controller either substantially simultaneously or at a subsequent time according to either periodic programming executed by game processor 205 or a triggering event, such as a jackpot or large win, at a respective gaming machine 100. In the event that gaming machines 100 have cameras installed, the respective players' video images may be displayed on overhead display 413 along with the content of the player's display 100 and any associated audio feed.

In one or more embodiments, game server 403 may provide server-based games and/or game services to network connected gaming devices, such as gaming machines 100 (which may be connected by network cable or wirelessly). Progressive server 407 may accumulate progressive awards by receiving defined amounts (such as a percentage of the wagers from eligible gaming devices or by receiving funding from marketing or casino funds) and provide progressive awards to winning gaming devices upon a progressive event, such as a progressive jackpot game outcome or other triggering event such as a random or pseudo-random win determination at a networked gaming device or server (such as to provide a large potential award to players playing the community feature game). Accounting server 411 may receive gaming data from each of the networked gaming devices, perform audit functions, and provide data for analysis programs, such as the IGT Mariposa program bundle.

Player account server 409 may maintain player account records, and store persistent player data such as accumulated player points and/or player preferences (e.g. game personalizing selections or options). For example, the player tracking display may be programmed to display a player menu that may include a choice of personalized gaming selections that may be applied to a gaming machine 100 being played by the player.

In one or more embodiments, the player menu may be programmed to display after a player inserts a player card into the card reader. When the card reader is inserted, an identification may be read from the card and transmitted to player account server 409. Player account server 409 transmits player information through network controller 210 to user interface 220 for display on the player tracking display. The player tracking display may provide a personalized welcome to the player, the player's current player points, and any additional personalized data. If the player has not previously made a selection, then this information may or may not be displayed. Once the player makes a personalizing selection, the information may be transmitted to game processor 205 for storing and use during the player's game play. Also, the player's selection may be transmitted to player account server 409 where it may be stored in association with the player's account for transmission to the player in future gaming sessions. The player may change selections at any time using the player tracking display (which may be touch sensitive or have player-selectable buttons associated with the various display selections).

In one or more embodiments, a gaming website may be accessible by players, e.g. gaming website 421, whereon one or more games may be displayed as described herein and played by a player such as through the use of personal computer 423 or handheld wireless device 425 (e.g. Blackberry® cell phone, Apple® iPhone®, personal data assistant (PDA), iPad®, etc.). To enter the website, a player may log in with a username (that may be associated with the player's account information stored on player account server 409 or be accessible by a casino operator to obtain player data and provide promotional offers), play various games on the website, make various personalizing selections, and save the information, so that during a next gaming session at a casino establishment, the player's playing data and personalized information may be associated with the player's account and accessible at the player's selected gaming machine 100.

Any use of ordinal terms such as “first,” “second,” “third,” etc., to refer to an element does not by itself connote any priority, precedence, or order of one element over another, or the temporal order in which acts of a method are performed. Rather, unless specifically stated otherwise, such ordinal terms are used merely as labels to distinguish one element having a certain name from another element having a same name (but for use of the ordinal term).

Further, as described herein, the various features have been provided in the context of various described embodiments, but may be used in other embodiments. The combinations of features described herein should not be interpreted to be limiting, and the features herein may be used in any working combination or sub-combination according to the invention. This description should therefore be interpreted as providing written support, under U.S. patent law and any relevant foreign patent laws, for any working combination or some sub-combination of the features herein.

The above described preferred embodiments are intended to illustrate the principles of the invention, but not to limit the scope of the invention. Various other embodiments and modifications to these preferred embodiments may be made by those skilled in the art without departing from the scope of the present invention.

1. A gaming machine for providing a wagering game, the gaming machine comprising:
a display, an audio device, a wager input device, and at least one electronic controller operatively coupled to the wager input device, the audio device, and the display and configured to execute instructions related to the wagering game and to cause cash value credits to be awarded to a player in response to wagering wins;
tangible, non-transitory electronically accessible memory coupled to the at least one electronic controller and containing program code executable by the at least one electronic controller to:
(a) receive an instruction that a first audio file is to be played as a music accompaniment during a game play session;
(b) in response, determining one or more musical beat rates and associated start times describing music recorded in the audio file;
(c) provide the one or more musical beat rates and associated start times to a timer;
(d) cause the first audio file to be played through the audio device while the game play session is in progress;
(e) while the file is played, cause the timer to measure time intervals between beats in the played audio, and send beat events to multimedia display program code synchronized with the beats in the played audio; and
(f) in response to the beat events and synchronized with the beats in the played audio, animating graphical display elements on the display during the game play session.

2. The gaming machine of claim 1, further comprising a lighting display including one or more lights having control electronics operatively coupled to the at least one electronic controller; and in which the multimedia display program code is further operable to respond to designated ones of the beat events by changing a lighting condition of the lighting display.

3. The gaming machine of claim 1, in which the program code further comprises instructions for providing game event audio accompanying selected events in the game play session, and further operable to mix the game event audio with the played audio such that designated sounds in the game event audio are synchronized with the beats in the played audio.

4. The gaming machine of claim 3, in which the game event audio comprises a bang-up soundtrack synchronized with the beats in the played audio, and a bang-up graphic sequence is displayed with the bang-up soundtrack showing credits incrementally awarded to a player also synchronized with the beats in the played audio.

5. The gaming machine of claim 1, in which the wagering game includes multiple paylines which are evaluated for game results in a payline evaluation of the game play session, and in which the program code further comprises instructions for providing a graphical display of cycling through the payline evaluation synchronized with the beats in the played audio.

6. The gaming machine of claim 1, in which the program code further comprises instructions for synchronizing animations of gaming symbols on an array of symbols to beats with the beats in the played audio.

7. The gaming machine of claim 1, in which the program code further comprises instructions to
(a) receive an instruction that a second audio file is to be played as a music accompaniment during the game play session in response to a transition to a bonus portion of the game play session;
(b) process the second audio file to determine one or more musical beat rates and associated start times describing music recorded in the audio file;
(c) provide the one or more musical beat rates and associated start times to a timer;
(d) cause the second audio file to be played through the audio device while the game play session is in progress;
(e) while the second audio file is played, causing the timer to measure time intervals between beats in the second played audio, and sending beat events to multimedia display program code synchronized with the beats in said second played audio; and
(f) in response to the beat events and synchronized with the beats in the second played audio, activating graphical display elements on the display during the game play session.

8. A method of providing a wagering game on a gaming machine having a display, a wager input device, an audio device, a display, and at least one electronic controller operatively coupled to the wager input device, the audio device, and the display and configured to execute instructions related to the wagering game, the method comprising:
(a) receiving an instruction that a first audio file is to be played as a music accompaniment during a game play session;
(b) in response, processing the first audio file to determine one or more musical beat rates and associated start times describing music recorded in the first audio file;
(c) providing the one or more musical beat rates and associated start times to a timer;
(d) causing the first audio file to be played through the audio device while the game play session is in progress;
(e) while playing the first audio file, measure with the timer the time intervals between beats in the played audio, and send beat events to multimedia display program code synchronized with the beats in the played audio; and
(f) in response to the beat events and synchronized with the beats in the played audio, animating graphical display elements on the display during the game play session.

9. The method of claim 8, further comprising responding to designated ones of the beat events by changing a lighting condition of a lighting display including one or more lights having control electronics operatively coupled to the at least one electronic controller.

10. The method of claim 8, further comprising providing game event audio accompanying selected events in the game play session, and further operable to mix the game event audio with the played audio such that designated sounds in the game event audio are synchronized with the beats in the played audio.

11. The method of claim 10, in which the game event audio comprises a bang-up soundtrack synchronized with the beats in the played audio, and a bang-up graphic sequence is displayed with the bang-up soundtrack showing credits incrementally awarded to a player also synchronized with the beats in the played audio.

12. The method of claim 8, in which the wagering game includes multiple paylines which are evaluated for game results in a payline evaluation of the game play session, the method further comprising providing a graphical display of cycling through the payline evaluation synchronized with the beats in the played audio.

13. The method of claim 8, further comprising synchronizing animations of gaming symbols on an array of symbols to beats with the beats in the played audio.

14. One or more tangible, computer readable media embodying a program product including program code instructions executable by a processor on a gaming machine while providing a wagering game, the program code executable to:
(a) receive an instruction that a first audio file is to be played as a music accompaniment during a game play session;
(b) in response, determining one or more musical beat rates and associated start times describing music recorded in the audio file;
(c) provide the one or more musical beat rates and associated start times to a timer;
(d) cause the first audio file to be played through an audio device while the game play session is in progress;
(e) while the file is played, cause the timer to measure time intervals between beats in the played audio, and send beat events to multimedia display program code synchronized with the beats in the played audio; and
(f) in response to the beat events and synchronized with the beats in the played audio, animating graphical display elements on the display during the game play session.

15. The computer readable media and program code of claim 14, further comprising program code for responding to designated ones of the beat events by changing a lighting condition of a lighting display including one or more lights having control electronics operatively coupled to the at least one electronic controller.

16. The computer readable media and program code of claim 14, in which the program code further comprises instructions for providing game event audio accompanying selected events in the game play session, and further operable to mix the game event audio with the played audio such that designated sounds in the game event audio are synchronized with the beats in the played audio.

17. The computer readable media and program code of claim 14, in which the game event audio comprises a bang-up soundtrack, and the program code further comprises instructions for synchronizing the bang-up soundtrack with the beats in the played audio and displaying a bang-up graphic sequence with the bang-up soundtrack showing credits incrementally awarded to a player also synchronized with the beats in the played audio.

18. The computer readable media and program code of claim 14, in which the wagering game includes multiple paylines which are evaluated for game results in a payline evaluation of the game play session, and in which the program code further comprises instructions for providing a graphical display of cycling through the payline evaluation synchronized with the beats in the played audio.

19. The computer readable media and program code of claim 14, in which the program code further comprises instructions for synchronizing animations of gaming symbols on an array of symbols to beats with the beats in the played audio.

20. The computer readable media and program code of claim 14, in which the program code further comprises instructions to
(a) receive an instruction that a second audio file is to be played as a music accompaniment during the game play session in response to a transition to a bonus portion of the game play session;
(b) process the second audio file to determine one or more musical beat rates and associated start times describing music recorded in the audio file;
(c) provide the one or more musical beat rates and associated start times to a timer;
(d) cause the second audio file to be played through the audio device while the game play session is in progress;
(e) while with the timer, measuring time intervals between beats in said second played audio, and sending beat events to multimedia display program code synchronized with the beats in said second played audio; and
(f) in response to the beat events and synchronized with the beats in said second played audio, activating graphical display elements on the display during the game play session.
